(19) United States
(12) Patent Application Publication
(10) Pub. No.: US 2011/0160968 A1
(43) Pub. Date: Jun. 30, 2011

(54) WORK IMPLEMENT CONTROL BASED ON WORKED AREA

(75) Inventor: Jacob Van Bergeijk, Hesston, KS (US)

(73) Assignee: AGCO Corporation, Duluth, GA (US)

(21) Appl. No.: 12/649,034

(22) Filed: Dec. 29, 2009

(51) Int. Cl. G06F 7/00

(52) U.S. Cl. 701/50

(57) ABSTRACT

Control of a work implement may be provided. A location and a trajectory associated with a machine may be received. According to the location and trajectory, it may be determined whether the machine is entering an unworked area. If the machine is entering the unworked area, a work implement of the machine may be engaged.

### BACKGROUND

Work implement control is a process for engaging and/or disengaging a work implement based on knowledge of a previously worked area. In some situations, multiple machines may be in use in a single working area. For example, multiple combine harvesters may be collecting crop material in the same field. The conventional strategy would be for a human operator to manually engage a header as the harvester enters an unworked area. This often causes problems because the conventional strategy does not always result in complete coverage, particularly for dusk or nighttime operations. For example, an operator may engage the header too late, missing a portion of the worked area, or may leave the header engaged when unnecessary, resulting in additional wear on the components and a potential safety hazard.

### SUMMARY

Consistent with embodiments of the present invention, systems and methods are disclosed for controlling a work implement. A location and a trajectory associated with a machine may be received. According to the location and trajectory, it may be determined whether the machine is entering an unworked area. If the machine is entering the unworked area, a work implement of the machine may be engaged.

It is to be understood that both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is an illustration of an apparatus comprising a controllable work element;

FIG. 3 is a flow chart of a method for controlling an implement work state;

FIG. 4 is a diagram illustrating a field layout; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Work implement control based on worked area data may be provided. Consistent with embodiments of the present invention, an agricultural machine may be equipped with a navigation system and/or an automated control system, such as the Auto-Guide™ system produced and distributed by AGCO® of Duluth, Ga., to assist an operator in performing their work. As the machine works the field, a series of data points may be established that may indicate what portions of the field have already been worked. For example, as a combine harvester traverses a field row collecting crop material, a Global Positioning System (GPS) on the harvester may record the area worked along with additional data such as the harvester's speed, direction, amount of crop material collected, and fuel remaining. These data points may be shared with other machines working in the same field, may be stored to an on-board computer, and/or may be transmitted to a field management system, such as the GTA Software Suite produced and distributed by AGCO® of Duluth, Ga. These data points may be compared to known boundaries of a field to determine what area or areas within the field remain unworked. These unworked areas may then be provided to machines working the field, and the work implements may be engaged automatically as the machine enters an unworked area.

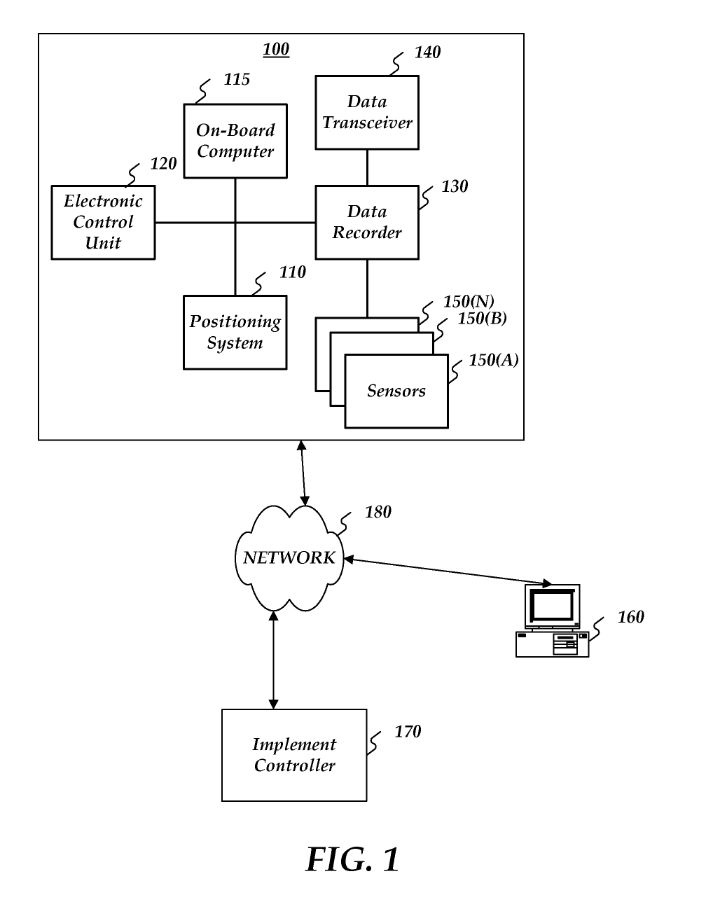

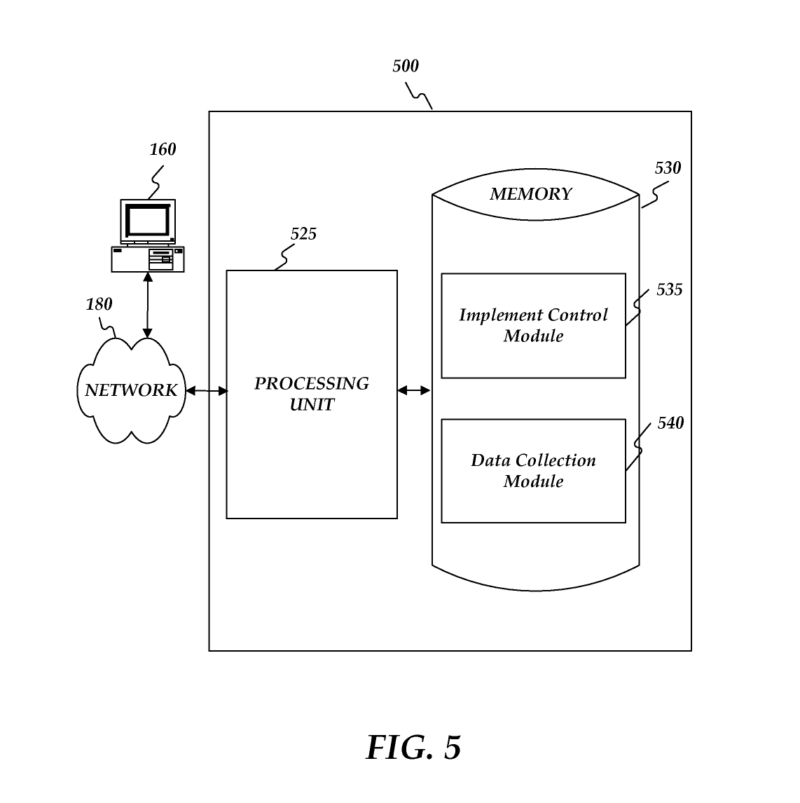

FIG. 1 is a block diagram of an operating environment for providing work implement control. The operating environment may comprise a first implement controller 100 comprising a positioning system 110, an on-board computer 115, an electronic control unit 120, a data recorder 130, and a data transceiver 140. Data recorder 130 may be coupled to a plurality of sensors 150(A)-150(N). Positioning system 110 may comprise, for example, a GPS system. Electronic control unit 120 may comprise an autosteer system operative to control various aspects of an apparatus' functionality, such as speed, direction, and work state (i.e., whether the work implement is engaged or disengaged). The operating environment may further comprise a field management system 160 and a second implement controller 170 communicatively coupled by a network 180. On-board computer 115 and/or field management system 160 may each comprise a computing device 500 as described in greater detail below with respect to FIG. 5.

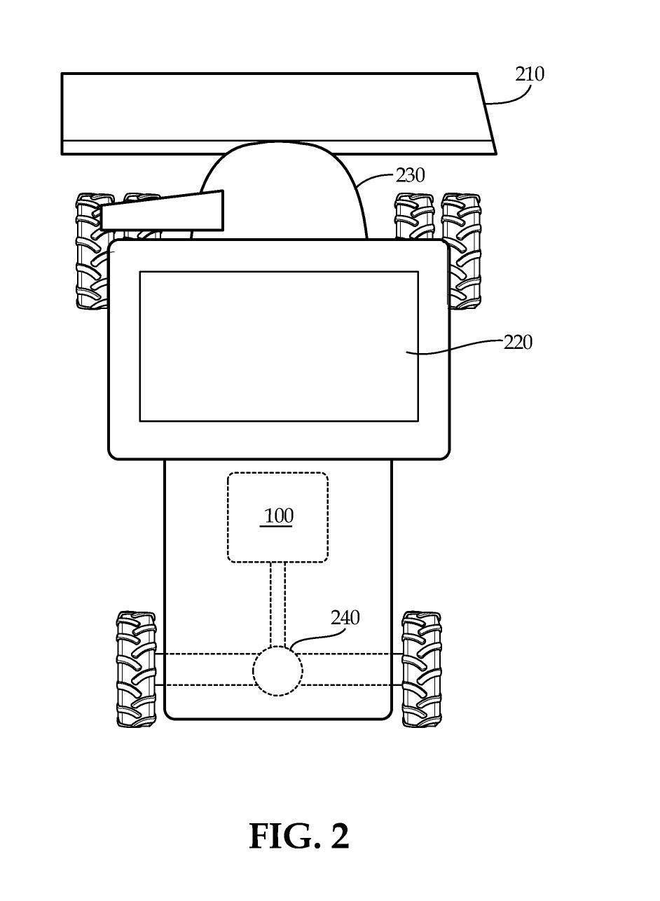

FIG. 2 is a block diagram of an apparatus 200 for generating a wayline. Apparatus 200 may comprise, for example, a harvester comprising a work implement 210, a harvested material bin 220, and an operator cab 230. Apparatus 200 may further comprise a drive system 240 comprising an engine and a steering linkage (not shown) coupled to the components of implement controller 100. Further details regarding the components of a combine harvester are disclosed in U.S. Pat. No. 5,873,227, which is hereby incorporated by reference in its entirety. Data recorder 130 may be operative to record data points associated with apparatus 200 at various intervals based on factors such as speed, orientation, time, and/or work performed. For example, data recorder 130 may create a data point every minute recording a current speed and direction, whether or not work implement 210 is active, a crop yield for the area covered, a current level of harvested material bin 220, and an estimated time until harvested material bin 220 may be full. Consistent with embodiments of the invention, data recorder 130 may be operative to record data points more often when apparatus 200 is moving along a curve than when moving in a straight line in order to more accurately reflect the path followed.

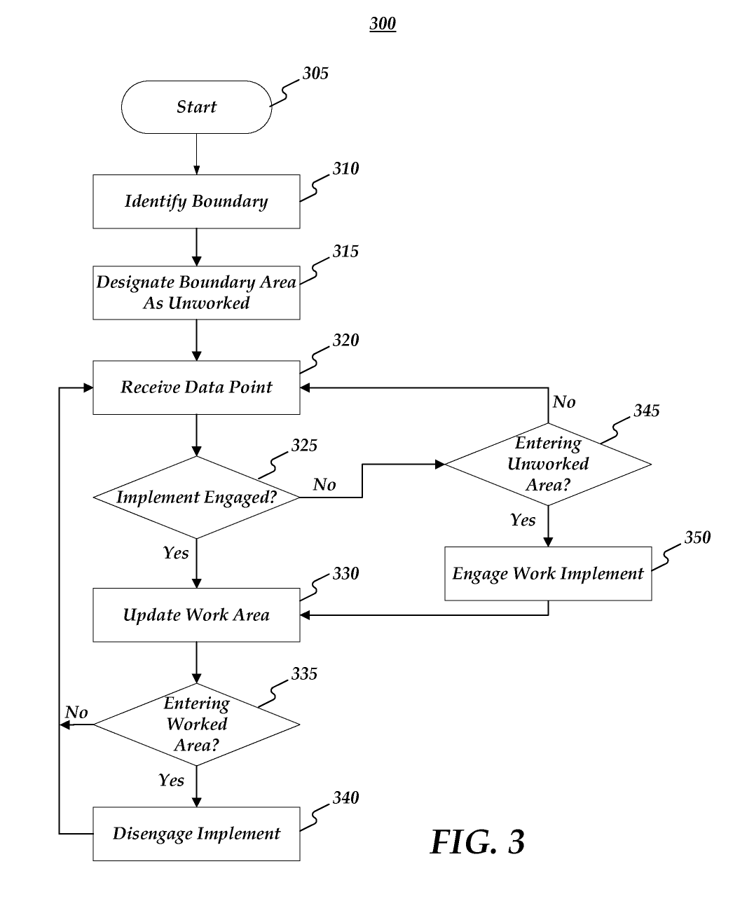

FIG. 3 is a flow chart setting forth the general stages involved in a method 300 for providing guidance using a worked edge. FIG. 3 is a flow chart setting forth the general stages involved in a method 300 consistent with an embodiment of the invention for providing wayline guidance using a worked edge. Method 300 may be implemented using computing device 500 as described in more detail below with respect to FIG. 5. Ways to implement the stages of method 300 will be described in greater detail below.

Method 300 may begin at starting block 305 and proceed to stage 310 where computing device 500 may identify a field boundary. For example, the boundary may comprise a series of geographical coordinates delineating a work area and/or make use of other features such as roads, rivers, fences, etc to surround the work area.

From stage 310, method 300 may advance to stage 315 where computing device 500 may designate the work area within the boundary as unworked. For example, a particular field to be harvested may be identified according to its boundary and the area within that boundary designated as unworked prior to commencement of the day's operations.

After designating the bounded field as unworked at stage 315, method 300 may advance to stage 320 where computing device 500 may receive a data point. For example, a machine such as apparatus 200 may approach the field boundary and enter the unworked area. As the machine traverses the field, it may periodically generate a data point associated with information about the machine such as location, trajectory, work state, and/or speed.

From stage 320, method 300 may advance to stage 325 where computing device 500 may determine whether a work implement is engaged. For example, on board computer 115 may query electronic control unit 120 to receive a report of a status of work implement 210 (e.g., engaged, disengaged, locked, cooldown, startup), including any configurable adjustments such as a height, RPM, or speed.

If, at stage 325, computing device 500 determines that the work implement is engaged, method 300 may advance to stage 330 where computing device 500 may update a work area. For example, field management system 160 may compute a harvested area based on a data point received from a combine harvester machine. This harvested area within the field boundary may then be designated as worked for future determinations.

From stage 330, method 300 may advance to stage 335 where computing device 500 may determine whether a machine associated with the data point is approaching and/or entering a worked area. If not, method 300 may return to stage 320 where computing device 500 may receive a next data point. Otherwise, method 300 may advance to stage 340 where computing device 500 may disengage the work implement. For example, field management system 160 and/or on-board computer 115 may determine that apparatus 200 comprises an engaged harvester approaching an edge of an unworked area and is about to enter a previously worked area. Electronic control unit 120 may be instructed to disengage work implement 210 as apparatus 200 enters and/or approaches the previously worked area. Method 300 may then return to stage 320.

If, at stage 325, computing device 500 determines that the work implement is not engaged, method 300 may advance to stage 345 where computing device 500 may determine whether the machine is entering an unworked area. For example, on-board computer 115 may receive periodic updates of areas within the field boundary that have been worked, while other areas within the field boundary may be designated as unworked. Positioning system 110 may be operative to provide a location, speed, and/or trajectory of apparatus 200 that on-board computer 115 may compare to the updated worked/unworked areas that may be received, for example, from field management system 160. Consistent with embodiments of the invention, field management system 160 may receive location data points generated by implement controller 100 and respond with evaluations as to whether apparatus 200 is entering or leaving a worked or unworked area.

If computing device 500 determines that the machine is not entering an unworked area at stage 345, method 300 may return to stage 320. Otherwise, method 300 may proceed to stage 350 where computing device 500 may engage the work implement. For example, on-board computer 115 may instruct electronic control unit to activate work implement 210. Consistent with embodiments of the invention, computing device 500 may take a current speed of apparatus 200 and a start-up time for work implement 210 into account when engaging work implement 210. That is, is work implement 210 requires ten seconds to fully engage, such as bringing a cutterbar up to speed and/or adjusting a height of a header mounting, computing device 500 may begin engaging work implement 210 at a point ten seconds' travel from the unworked area at a current speed of apparatus 200. Computing device 500 may also and/or alternatively be operative to reduce a speed of apparatus 200 to allow work implement 210 time to fully engage before apparatus 200 enters the unworked area. Method 300 may then return to stage 330 where computing device 500 may update the area known to have been worked.

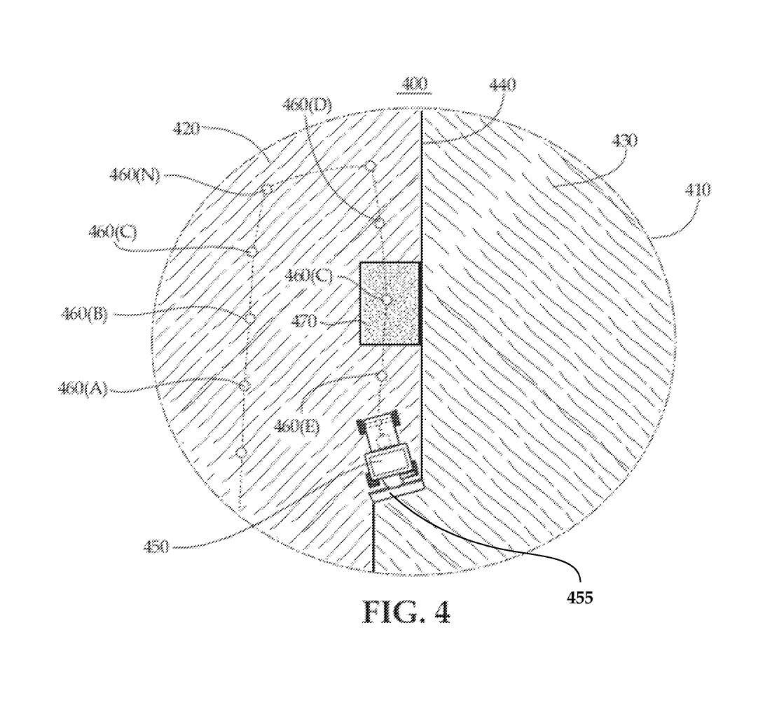

FIG. 4 is a diagram illustrating a field 400 comprising a field boundary 410, a worked area 420, and an unworked area 430. Worked area 420 and unworked area 430 may be divided by a worked edge 440. Worked edge 440 may be established as a machine 450 with an active work implement 455 traverses field 400. Machine 450 may generate a plurality of data points 460(A)-460(N) each associated with a location, trajectory, and/or speed of machine 450. Consistent with embodiments of the invention, a work area 470 may be computed according to the location of at least one data point, such as data point 460(C), the speed of machine 450, and/or the width of work implement 455. For example, work area 470 may be computed as an area having a width equal to that of work implement 455 and a length equal to the distance halfway between a previous data point 460(D) and a next data point 460(E). For another example, work area 470 may be computed as an area having a width of the width of work implement 455 and a length of the distance between two successive data points, such as data point 460(A) and data point 460(B). For a third example, work area 470 may be computed as an area based on a coverage area of a work implement, such as a sprayer, extended over a distance known to be covered by machine 450 according to the location and speed of machine 450. Thus, the work area may be offset from the location of machine 450 itself.

An embodiment consistent with the invention may comprise a system for controlling a work implement. The system may comprise a memory storage and a processing unit coupled to the memory storage. The processing unit may be operative to receive a location associated with a machine, receive a trajectory of the machine, and determine whether the machine is entering an unworked or a worked area. The processing unit may be operative to engage the machine's work implement if the machine is entering an unworked area or disengage the work implement if the machine is entering a worked area. The processing unit may be further operative to adjust operations of the work implement based on identification of the work to be undertaken, such as by adjusting a cutterbar height according to a type of crop to be harvested. The processing unit may also be operative to analyze data points collected by the machine to identify areas within a field boundary worked by the machine and update a status for a subset of the field to indicate that subset has been worked. The processing unit may be further operative to measure a speed of the machine and initiate engagement of the work implement to take account of the time needed to fully engage the implement and the time before the machine enters the unworked area. The processing unit may be further operative to identify an amount of time, based on a speed and/or trajectory of the apparatus, before the apparatus reaches an unworked area, determine whether a start-up time for the work implement to become engaged is less than the amount of time before the apparatus reaches the second portion of the work area, and if the start-up time for the work implement to become engaged is less than the amount of time before the apparatus reaches the second portion of the work area, reduce the speed of the apparatus.

Another embodiment consistent with the invention may comprise a system for controlling a work implement, the system comprising a memory storage coupled to a processing unit. The processing unit may be operative to identify an initial field boundary, receive a plurality of data points comprising a worked location within the initial field boundary, designate a subset of the unworked area within the initial field boundary as worked according to the plurality of data points, determine whether a work implement is approaching a remaining unworked area within the initial field boundary, and, if so, engage the work implement. The processing unit may be further operative to receive a work area size associated with each of the plurality of data points, sort the plurality of data points in an order of recording, and identify a work path and work area width associated with the plurality of data points.

FIG. 5 is a block diagram of a system including a computing device 500. As shown in FIG. 5, computing device 500 may include a processing unit 525 and a memory 530. Memory 530 may comprise software modules such as an implement control module 535 and a data collection module 540. Field management system 160 may comprise a similar structure and may communicate with computing device 500 over network 180. While executing on processing unit 525, implement control module 535 and data collection module 540 may perform processes for receiving a position, creating a data point and/or a way point, transmitting data to and/or receiving data from field management system 160, and/or collecting sensor data. Computing device 500 may be operative to perform for example, one and/or more of method 300's stages as described above with respect to FIG. 3. Furthermore, one and/or more of method 300's stages may be performed by field management system 160.

Computing device 500 and/or field management system 160 may be implemented using a personal computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

Network 180 may comprise, for example, a local area network (LAN) or a wide area network (WAN). Such networking environments are commonplace in work sites, offices, enterprise-wide computer networks, intranets, and the Internet. When a LAN is used as network 180, a network interface located at any of the processors may be used to interconnect any of the processors. The processors may typically include an internal or external modem (not shown) or other means for establishing communications. Further, in utilizing network 180, data sent over network 180 may be encrypted to insure data security by using known encryption/decryption techniques.

A wireless communications system, or a combination of wire line and wireless may be utilized as network 180 in order to, for example, send and receive data points, way points, and/or waylines, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802), a Bluetooth interface, another RF communication interface, and/or an optical interface.

Computing device 500 may also transmit data by methods and processes other than, or in combination with, network 180. These methods and processes may include, but are not limited to, transferring data via, diskette, flash memory sticks, CD ROM, facsimile, conventional mail, an interactive voice response system (IVR), or via voice over a publicly switched telephone network.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for controlling a work implement, the method comprising:
receiving a location associated with a machine comprising a harvester;
receiving a trajectory of the machine;
determining whether the machine is entering an unworked area according to the location and trajectory of the machine; and
in response to determining that the machine is entering an unworked area, engaging a work implement associated with the machine wherein the work implement comprises a cutting head.

2. The method of claim 1, further comprising:
determining whether the machine is entering a worked area; and
in response to determining that the machine is entering a worked area, disengaging the work implement associated with the machine.

3. The method of claim 1, further comprising:
in response to engaging the work implement, designating the location associated with the machine as a worked area.

4. The method of claim 3, wherein engaging the work implement comprises lowering the cutting head to an engaged position and activating a cutterbar coupled to the cutting head.

5. The method of claim 4, further comprising:
receiving an identification of a type of crop to be harvested; and
adjusting a height of the cutting head according to the type of crop to be harvested.

6. The method of claim 1, further comprising logging a plurality of data points while the work implement is engaged, wherein each of the plurality of data points comprises a current location of the machine.

7. The method of claim 6, further comprising analyzing the logged plurality of data points to identify at least one worked area of a field.

8. The method of claim 7, wherein analyzing the logged plurality of data points to identify the at least one worked area comprises:
identifying a boundary of the field;
designating the field within the boundary as unworked; and
updating a subset of the field associated with the logged plurality of data points as worked.

9. The method of claim 8, wherein updating a subset of the field associated with the logged plurality of data points as worked comprises extrapolating a work area of the work implement according to the current location associated with each of the plurality of data points and a width of the work implement.

10. The method of claim 1, further comprising:
measuring a speed of the machine;
receiving a start-up time value comprising an amount of time needed to fully engage the work implement; and
beginning to engage the work implement at a time prior to entering the unworked according to the speed of the machine and the start-up time value.

11. An apparatus for controlling a work implement, the apparatus comprising:
a control unit operative to:
adjust a height of the work implement, and
modify a work state of the work implement;
a memory storage coupled to the control unit; and
a processing unit coupled to the memory storage and the control unit, wherein the processing unit is operative to:
identify a work area boundary,
receive a status of the work implement from the control unit,
correlate a location of the work implement with the received status of the work implement,
identify a first portion of the work area within the boundary as having been worked by the work implement according to the received status and correlated location of the work implement,
determine whether the apparatus is located inside the work area boundary,
in response to determining that the apparatus is located inside the work area boundary, determine whether the apparatus is not inside the first portion of the work area identified as having been worked, and
in response to determining that the apparatus is not inside the first portion of the work area identified as having been worked, determine whether the work implement is engaged, and
in response to determining that the work implement is not engaged, instruct the control unit to engage the work implement.

12. The apparatus of claim 11, wherein the processing unit is further operative to provide the identified first portion of the work area to at least one other apparatus.

13. The apparatus of claim 11, wherein the processing unit is further operative to, in response to determining that the apparatus is not inside the first portion of the work area identified as having been worked:
identify a trajectory of the apparatus;
determine whether the trajectory of the apparatus indicates that the apparatus is approaching a second portion of the work area not identified as having been worked; and
in response to determining that the trajectory of the apparatus indicates that the apparatus is approaching the second portion of the work area not identified as having been worked, instruct the control unit to engage the work implement.

14. The apparatus of claim 13, wherein the processing unit is further operative to, in response to determining that the trajectory of the apparatus indicates that the apparatus is approaching the second portion of the work area not identified as having been worked:
identify an amount of time before the apparatus reaches the second portion of the work area;
determine whether a start-up time for the work implement to become engaged is less than the amount of time before the apparatus reaches the second portion of the work area; and
in response to determining that the start-up time for the work implement to become engaged is less than the amount of time before the apparatus reaches the second portion of the work area, reduce a speed of the apparatus.

15. A system for controlling a work implement, the system comprising:
a memory storage; and
a processing unit coupled to the memory storage, wherein the processing unit is operative to:
identify an initial field boundary, wherein the initial field boundary comprises an unworked area,
receive a first plurality of data points, wherein the first plurality of data points each comprise a worked location within the initial field boundary,
designate a subset of the unworked area within the initial field boundary as worked according to the first plurality of data points,
determine whether a work implement is approaching a remaining unworked area within the initial field boundary, and
in response to determining that the work implement is approaching a remaining unworked area within the initial field boundary, engage the work implement.

16. The system of claim 15, wherein being operative to designate a subset of the unworked area within the initial field boundary as worked according to the first plurality of data points comprises being operative to:
receive a work area size associated with each of the plurality of data points;
sort the plurality of data points in an order of recording, and
identify a work path and work area width associated with the plurality of data points.

17. The system of claim 16, wherein the work area size is computed according to a width of the work implement and a distance between at least two successive data points of the plurality of data points.

18. The system of claim 15, wherein the first plurality of data points is received from a first machine and the work implement is associated with a second machine.

19. The system of claim 15, wherein being operative to determine whether the work implement is approaching a remaining unworked area within the initial field boundary comprises being operative to evaluate a location, a trajectory, and a speed associated with the work implement.

20. The system of claim 19, wherein the processing unit is further operative to evaluate the location, the trajectory, and the speed associated with the work implement on a periodic basis.
